(19) United States
(12) Patent Application Publication
(10) Pub. No.: US 2007/0112557 A1
(43) Pub. Date: May 17, 2007

(54) Translation System And Method

(75) Inventors: Chengshing Lai, Taipei (TW); Jing Liu, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Inventec Appliances Corp., Taipei (TW)

(21) Appl. No.: 11/558,391

(22) Filed: Nov. 9, 2006

(30) Foreign Application Priority Data
Nov. 11, 2005 (TW) 094139658

(51) Int. Cl. G06F 17/21

(52) U.S. Cl. 704/10

(57) ABSTRACT

The invention relates a translation system for a portable communication apparatus and a method thereof. The translation system includes a storage unit, an input unit, a processing module, and a display unit. The storage unit stores an inquiry datum being one of a short message and an e-mail transceived by the portable communication apparatus. The input unit provides a conditional command and determines whether the inquiry datum is to be translated. The processing module transforms the inquiry datum into a translation datum based on the conditional command and a dictionary datum, and the display unit shows the translation datum.

### FIELD OF THE INVENTION

The present invention relates to the translation system and method, and more particular to the translation system and method for a portable communication apparatus.

### BACKGROUND OF THE INVENTION

Since the popularity of cell phone is rapidly growing, the cell phone factory has cooperated with the internet work proprietor and the fixed communication network proprietor so as to manufacture the cell phone having the services provided from the internet work proprietor and the fixed communication network proprietor. In addition, in order to satisfy the user's various demands, it has become a trend to provide the cell phone capable of transmitting and/or receiving the information, such as the short message and e-mail, anytime and anywhere. Furthermore, with the developments in transportations and information transmissions, the opportunity of contacting with the foreigner and the foreign business has greatly increased. Accordingly, it is usually necessary to translate a short message or an e-mail from a language to another language and some translation problems are often resulted therefrom. Taking people whose first language is not English as an example, it is usually necessary to translate a short message or an e-mail into English or translate the English short message or an e-mail into his first language. Undoubtedly, there exist some translation problems during the translation process.

The prior cell phone has owned the property of providing a glossary and a user could find an English term from the cell phone. Please refer to FIG. 1, which shows a diagram of the prior cell phone. As shown in FIG. 1, the cell phone 1 includes a main body 11 and an inquiring device 12. The main body 11 provides an inquiring signal 111 to the inquiring device 12, and the inquiring device 12 includes a dictionary database 121, such as a Chinese-English dictionary database or an English-Chinese dictionary database. After receiving the inquiring signal 111, the inquiring device 12 would provide a response datum 122, such as a translation of a term, back to the main body 11 via a data processing procedure based on the dictionary database 121. After that, the main body 11 would display the response datum 122.

Please refer to FIGS. 1 and 2, where FIG. 2 shows a diagram of the response for the prior cell phone, where the term, “write”, is taken as an example. Firstly, the user inputs the desired term, “write”, into the main body 11 and then the main body 11 would generate an inquiring signal 111 to the dictionary database 121 so as to search out a response datum 122. After that, the response datum 122 would be transmitted to the main body 11, and the main body 11 shows the response datum 122. Accordingly, the user could inquire a desired term with the cell phone 1. Nevertheless, while using the prior cell phone, the user needs to input the inquiry one by one, such as one term by one term, and it is impossible to translate a sentence by directly input the whole sentence into the cell phone. In addition, the translation of the full text of a short message or an e-mail, which is to be transmitted and/or is stored and/or is received by the cell phone, is still unable directly obtained from the prior cell phone. As above, there exist inconveniences in the use of reading and applying the prior cell phone.

In view of the mentioned above, it is an object to provide the translation system and method for a portable communication apparatus, such as a cell phone. In particular, it is an object to provide the translation system and method applying a translation module so as to translate a sentence or a paragraph of a short message or an e-mail on a portable communication apparatus.

### SUMMARY OF THE INVENTION

In order to achieve the mentioned object, the present invention provides a translation system for a portable communication apparatus. The translation system includes a storage unit, an input unit, a processing module, and a display unit. The storage unit stores an inquiry datum, such as the short message and e-mail. The input unit provides a conditional command and determines whether the inquiry datum is to be translated. The processing module transforms the inquiry datum into a translation datum based on the conditional command and a dictionary datum. The display unit shows the translation datum.

In addition, a translation method for a portable communication apparatus is also provided. The translation method includes the steps of: a) providing a storage unit having at least an inquiry datum; b) inputting a conditional command via an input unit so as to determine whether the inquiry datum is to be translated; and c) providing a processing module to translate the inquiry datum into a translation datum based on the conditional command and a predetermined database having at least a dictionary database. Accordingly, it is achievable to automatically translate the short message and e-mail and increase the convenience in reading the short message and e-mail.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 shows a diagram of the cell phone in the prior art;

FIG. 2 shows a diagram of the response for the prior cell phone;

FIG. 3 shows the block diagram of the translation system according to a preferred embodiment of the present invention;

FIG. 4 shows a flow chart of the translation method according to the present invention;

FIG. 5 shows a flow chart of the translation method according to a preferred embodiment of the present invention; and

FIGS. 6 and 7 show the diagrams of the display unit under different languages according to a preferred embodiment of the present invention.

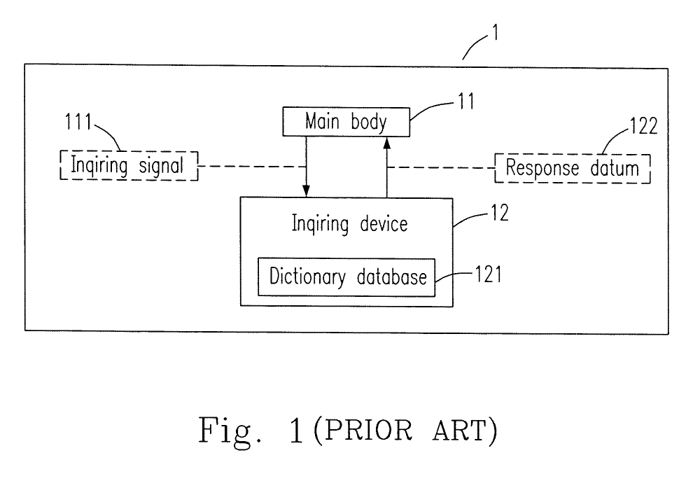

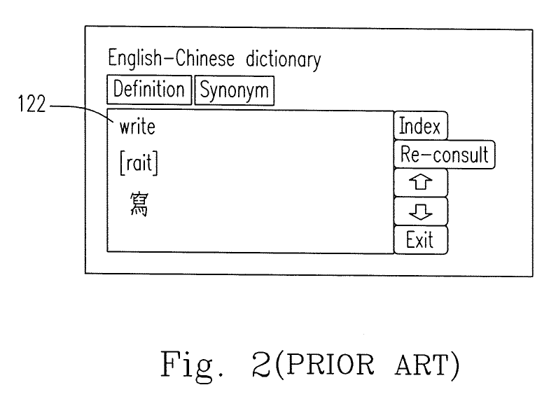

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed. In addition, the same elements would be illustrated by the same reference numerals.

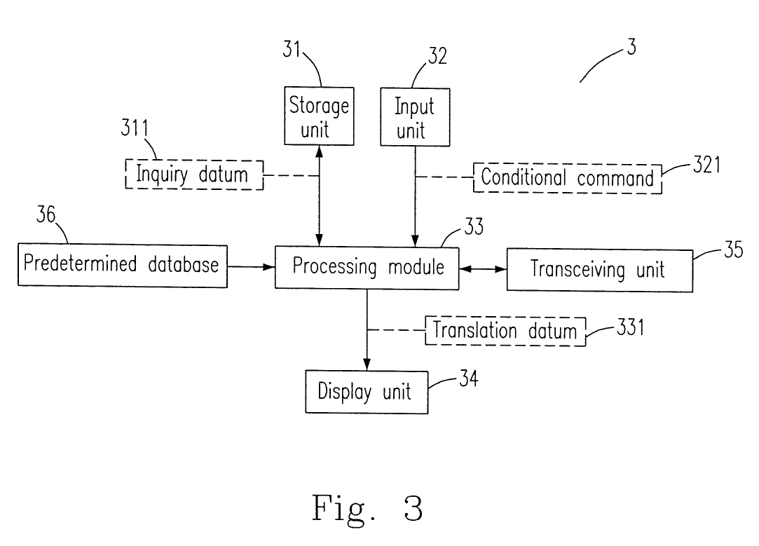

Please refer to FIG. 3, which is a block diagram of the translation system according to the present invention, where the translation system is suitable for a portable communication apparatus, such as a cell phone. As show in FIG. 3, the translation system 3 includes a storage unit 31, an input unit 32, a processing module 33, a display unit 34 and a transceiving unit 35. The storage unit 31 stores an inquiry datum 331, such as a short message or an e-mail. The input unit 32 could be a keyboard, a mouse, or an input pen for inputting a conditional command 321 and determine whether the portable communication apparatus (not shown) translates the inquiry datum 331. The processing module 33 transforms the inquiry datum 311 into a translation datum 331 according to the conditional command 321 and a predetermined database 36. The predetermined database 36 includes at least a dictionary database. The display unit 34 shows the translation datum 331. The transceiving unit 35 could be a Global System for Mobile Communications (GSM) module, a Code Division Multiple Access (CDMA) module, or a Personal Handyphone System (PHS) module for transceiving the inquiry datum 311 and the translation datum 331, wherein either of the inquiry datum 311 and the translation datum 331 could be a short message or an e-mail. In addition, the conditional command 321 could be one of a Chinese translation command and an English translation command. The inquiry datum 311 is a language term being one of a Chinese term and an English term. The predetermined database 36 includes an English-Chinese dictionary database and a Chinese-English database. The predetermined database 36 could be built in a database of the portable communication apparatus (not shown) or built in a database electrically connected with the portable communication apparatus and a server (not shown). The portable communication apparatus (not shown) is electrically connected to the server via a communication network so as to communicate with the predetermined database 36.

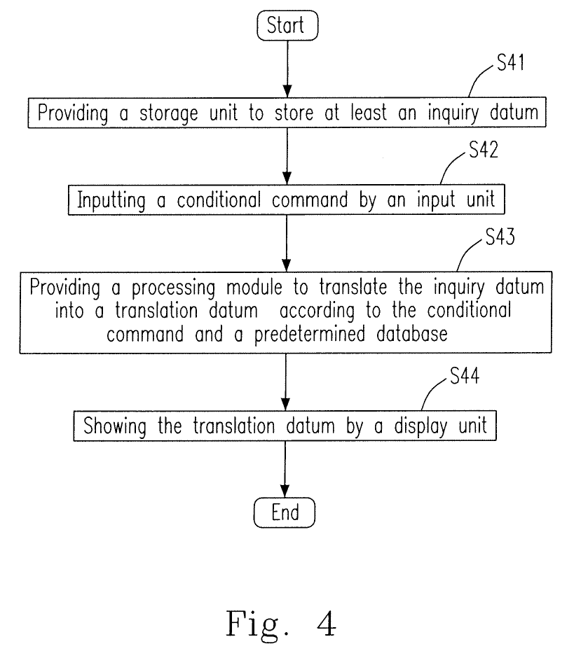

Please refer to FIG. 4, which is a flow chart of the translation method according to the present application. The translation method includes at least the following steps S41, S42, S43, and S44. After beginning, it is step S41. In step S41, a storage unit is provided to store at least an inquiry datum. In step S42, a conditional command is inputted via an input unit so as to indicate whether the portable communication apparatus translates the inquiry datum. In step S43, a processing module is provided and then the inquiry datum is translated into a translation datum by the processing module according to the conditional command and a predetermined database. The predetermined database includes at least a dictionary database. In step S44, the translation datum is displayed on a display unit. And then the translation process is ended. Accordingly, it is achievable to automatically translate the short message and e-mail and increase the convenience in reading the short message and e-mail.

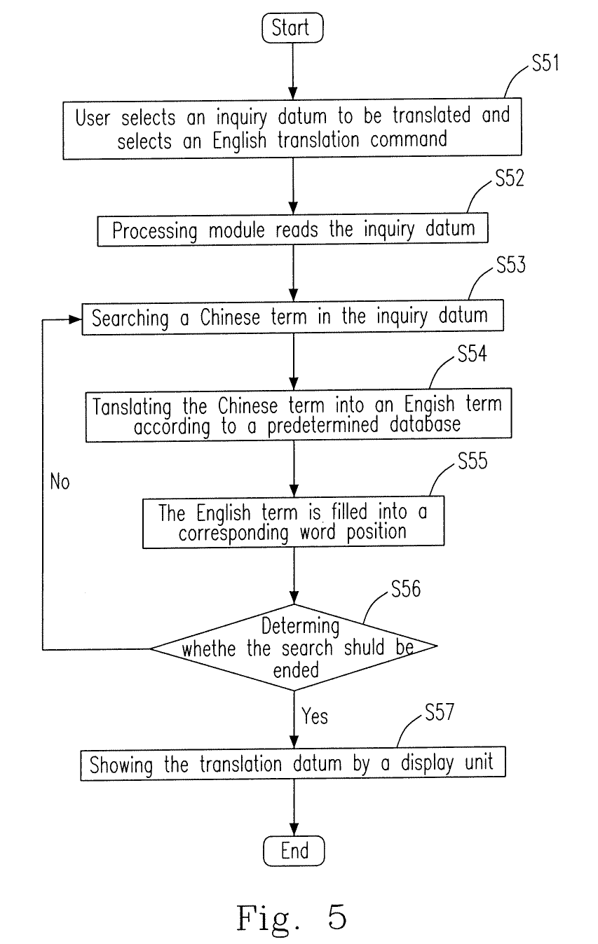

Please refer to FIG. 5, which is a flow chart of the translation method according to a preferred embodiment of the present invention, where an example of translating a Chinese term into an English term is shown. The flow chart shown in FIG. 5 at least includes the following steps S51, S52, S53, S54, S55, S56, and S57. After beginning, the user selects an inquiry datum to be translated and selects an English translation command in step S51. In step S52, the processing module reads the inquiry datum. In step S53, the processing module searches a Chinese term in the inquiry datum. In step S54, the processing module translates the Chinese term into an English term based on a predetermined database. After that, the English, term is filled into a corresponding word position in step S55. In step S56, it is to be determined whether the search should be ended. If yes, it comes the step S57, where a translation datum is displayed on a display unit. If not, the translation method goes back step S53 to research a Chinese term in the inquiry datum. Finally, the translation method is ended.

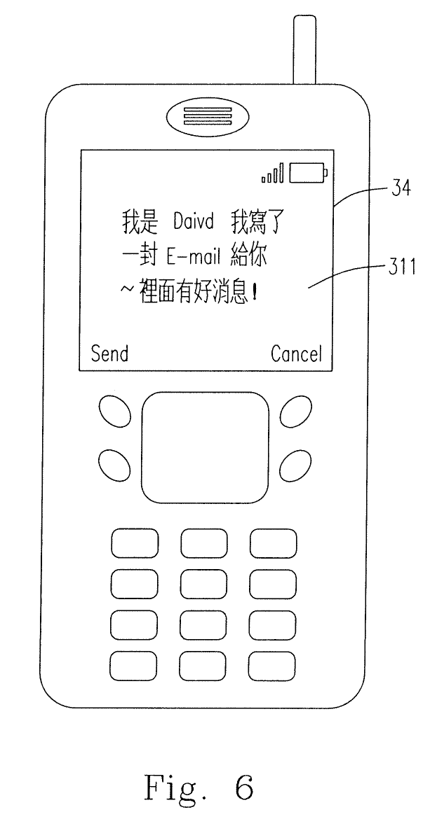

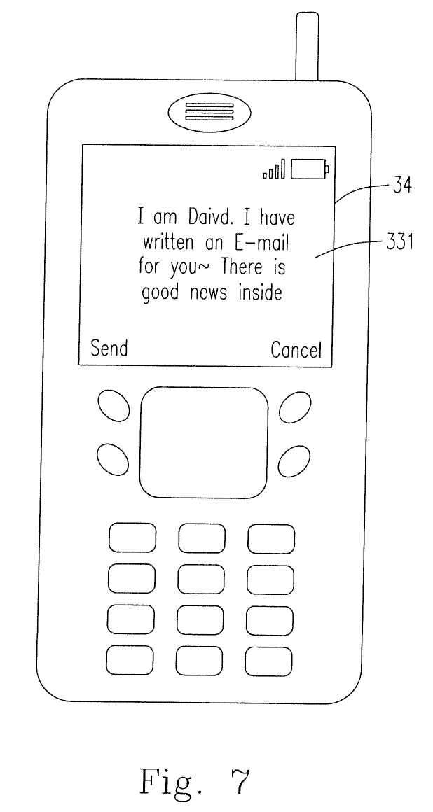

Please refer to FIGS. 6 and 7, which show the diagrams of the display unit under different languages according to a preferred embodiment of the present invention. As shown in FIG. 6, the display unit 34 shows an inquiry datum 311 (in Chinese) being a short message the user wants to send out. Nevertheless, since the receiver is a foreign friend of the user, the user would translate the inquiry datum 311 (in Chinese) into English datum 331 as shown in FIG. 7 by the translation system and then the foreign receiver could read the translated short message. As mentioned above, the user could use the translation system to translate the received short messages and the e-mails and the short messages and e-mails to be sent, i.e. the user could carry out a Chinese translation procedure or an English translation procedure with the translation system. Accordingly, it is achievable to increase the convenience in reading.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A translation system for a portable communication apparatus, comprising:
a storage unit storing an inquiry datum being one of a short message and an e-mail transceived by the portable communication apparatus;
an input unit providing a conditional command and determining whether the inquiry datum is to be translated;
a processing module transforming the inquiry datum into a translation datum based on the conditional command and a dictionary datum; and
a display unit showing the translation datum.

2. A translation system as claimed in claim 1, wherein the portable communication apparatus is a cell phone.

3. A translation system as claimed in claim 1, wherein the input unit comprises a keyboard, a mouse, or an input pen.

4. A translation system as claimed in claim 1, wherein the conditional command is one of an English-Chinese translation command and a Chinese-English translation command.

5. A translation system as claimed in claim 1, wherein the dictionary datum is stored in a database.

6. A translation system as claimed in claim 5, wherein the database is built in the portable communication apparatus and the database is a Chinese-English dictionary database and/or an English-Chinese dictionary database.

7. A translation system as claimed in claim 5, wherein the database is connected with a server, and the portable communication apparatus is connected with the server via a communication network so as to be connected to the database.

8. A translation method for a portable communication apparatus, comprising steps of:
a) providing a storage unit storing an inquiry datum being one of a short message and an e-mail transceived by the portable communication apparatus;
b) providing a conditional command; and
c) translating the inquiry datum into a translation datum according to the conditional command and a dictionary datum.

9. A translation method as claimed in claim 8, wherein the step b) is performed by an input unit, wherein the input unit comprises a keyboard, a mouse, or an input pen.

10. A translation method as claimed in claim 8, wherein the step c) is performed by a processing module.

11. A translation method as claimed in claim 8, further comprising a step of showing the translation datum via a display unit.

12. A translation method as claimed in claim 8, wherein the conditional command is one of an English-Chinese translation command and a Chinese-English translation command.

13. A translation method as claimed in claim 8, wherein the dictionary datum is stored in a database.

14. A translation method as claimed in claim 13, wherein the database is built in the portable communication apparatus and the database is a Chinese-English dictionary database and/or an English-Chinese dictionary database.

15. A translation method as claimed in claim 13, wherein the database is connected with a server, and the portable communication apparatus is connected with the server via a communication network so as to be connected to the database.

16. A translation method as claimed in claim 8, wherein the portable communication apparatus is a cell phone.

17. A translation method for a portable communication apparatus transceiving a datum being one of a short message and an e-mail, comprising steps of:
a) selecting at least a part of the datum as an inquiry datum; and
b) translating the inquiry datum into a translation datum.
